(19) United States
(12) Patent Application Publication
(10) Pub. No.: US 2023/0290262 A1
(43) Pub. Date: Sep. 14, 2023

(54) SKILL LEARNING SYSTEMS AND METHODS

(71) Applicant: The System, Inc., San Francisco, CA (US)

(72) Inventor: David Newell Bossart, San Francisco, CA (US)

(73) Assignee: The System, Inc., San Francisco, CA (US)

(21) Appl. No.: 18/120,738

(22) Filed: Mar. 13, 2023

Related U.S. Application Data
(60) Provisional application No. 63/319,766, filed on Mar. 14, 2022.

(51) Int. Cl. G09B 7/08

(52) U.S. Cl. CPC G09B 7/08

(57) ABSTRACT

Systems and related methods are provided for testing a student where particular problem solving skills of a student are identified and computer based lessons are formulated based on the student's particular failings and skills associated with the failings. The systems and related methods include generating and displaying an aptitude test with a list of questions on a graphical user interface on the display; creating or updating a record of the questions from the aptitude test; correlating failed results of the aptitude test with one or more skills; generating a plurality of lesson courses for the one or more skills; and generating and displaying the plurality of lesson courses on the graphical user interface.

### CROSS-REFERENCE TO RELATED APPLICATIONS

This application claims the benefit of U.S. Provisional Application No. 63/319,766, filed Mar. 14, 2022, the entirety of which is incorporated by reference.

### BACKGROUND

In many teaching environments, there is poor association and follow-up between failures to learn problem solving skills and the means to enable a student to learn the missed skills. This is due to practical concerns of a live (in-person or on-line), multi-student classroom environment and how students are tested. Typically, results of a test are not returned for several days. In that time span, the student would not be expected to remember or identify all of the issues they had with test problems. In addition, practical burdens prevent teachers from formulating tutoring plans for the student. Tutors can be hired to address a student's specific needs, but the cost of hiring a tutor makes it impractical for most students, and in the era of pandemics impossible for even those with means to do so.

Computer-based learning has not addressed the issues of the classroom. A student can locate information on-line via search engines and even take computer based tests, but in use of such self-help no actual teaching to the student occurs and the student must connect the dots themselves, i.e., there is no follow-up or particularized focus on how to identify and address a student's particular misunderstanding of a problem solving skill. Accordingly, there is a need to provide students with a computer based, particularized teaching system.

### SUMMARY OF THE INVENTION

Embodiments relate to processor executed methods, systems, graphical user interfaces, and tangible computer-readable media for teaching students skill-based subject matter, such as math, computer programming, languages, science, engineering. Some embodiments relate to processor executed methods for tracking students' weaknesses and skills in more detail and specificity than a person could. In some embodiments, tracking hundreds of skills can occur without forgetting or neglecting a single one.

In some embodiments, a system is configured to optimize the sequence of lessons more effectively than a person could. In some embodiments, there is a specific order that skills must be built, so that the student can understand them, and this sequence is executed to foster a student's confidence in a way that a person could not.

In some embodiments, an inexhaustible problem bank with custom explanations (e.g., video explanations) for each problem is provided, so students never run out of practice problems and they can be shown exactly how to work out each problem they miss. Having an inexhaustible number of example problems and practice problems is incredibly beneficial and advantageous to traditional computer based training courses and classes taught by human teachers. In some embodiments, there can be over 200,000 such problems, where to create each by hand with its custom explanation would take over 83,333 hours. In some embodiments, video explanations can be played over and over without exhausting anyones patience, such as a tutor for instance. In some embodiments, explanations can be written typographically so they are easier to read than handwritten notes and the figures that are included are scaled and accurate.

In some embodiments, interactive lessons are provided that break down the material for students in a way that cannot be done by a human teacher. In some embodiments, parameters of an equations are changed so that a student can see the effect on its graph immediately, hence students will make connections that would have been impossible with a pen and paper or a book and a teacher. In some embodiments, changes can be illustrated in one graph and cause changes in another, so that students understand their interdependence. People can only draw graphs one at a time, so this would be impossible for a person to do. Even several people would never be synchronized to the extent required, and they would always block the figure they were creating as they made it.

Students will be able to work in privacy on their machines so they will not have to reveal their challenges to human teacher, which makes it easier to be completely honest about what they need help with. Because embodiments can be available anytime online (i.e., 24/7), students always have access to the materials, which would not be possible if learning from a human teacher. Further, students would have access to a voluminous amount of learning material, such as with a subscription for unlimited instruction or courses per month for instance. In this way, students could be working countless hours daily, weekly, and monthly, that could not practically be provided by a human teach.

Students can do a comprehensive assessment of their skill set for prior skills (e.g., algebra, pre-calculus) taken before, rather than just focusing on the current class (e.g., calculus), which is often challenging because of holes in their prior understanding. Further, students are enabled to build their skill set in a thorough and complete context, from the ground up, which no human teacher would ever practically be able to do because of all the details involved and because of the cost of hiring a person to make such a thorough assessment.

Some embodiments related to a method and/or computer-program product and/or system, where an aptitude test can be provided on a graphical user interface. The aptitude test can include a list of questions. A record of the questions can be created and/or updated from the aptitude test. Failed results of the aptitude test can be correlated with one or more skills. A plurality of lesson courses can be generated for the one or more skills. The plurality of lesson courses can be provided on the graphical user interface. Tracking all of the skills that a student lacks, dozens or hundreds at a time, is not something that a person could realistically do. Even with notes, a teacher instantaneously assemble a sequence of potentially hundreds of skills and have inexhaustible problems/examples at the ready.

In some embodiments, each lesson course of the plurality of lesson courses can include a plurality of lesson modules.

In some embodiments, each lesson module can include a video lesson and a static written lesson generated on the graphical user interface.

In some embodiments, the video lesson can include a question portion regarding a problem, and/or an animated portion illustrating a method of solving the problem, and/or a close captioned portion displaying animated text explanation of the animated portion.

In some embodiments, a first lesson module of the plurality of lesson modules can include a first video lesson and/or a first quiz.

In some embodiments, a second lesson module of the plurality of lesson modules cannot be accessed on the graphical user interface until the first quiz is passed.

In some embodiments, the at least one lesson course can include a plurality of quiz questions, and in some embodiments the plurality of quiz questions can be selected to not repeat questions from the record.

In some embodiments, the plurality of quiz questions can be selected from a database ranging from 100-500 questions.

In some embodiments, the plurality of lesson courses can be generated only for the one or more skills and not for skills passed in the aptitude test.

### BRIEF DESCRIPTION OF THE DRAWINGS

Reference will be made to the following Detailed Description, which is to be read in conjunction with the accompanying drawings, wherein according to some embodiments:

FIG. 1 illustrates a block diagram of a skill teaching computer system for providing a customized plurality of lessons to a student user based on skills associated with the student user, according to some embodiments.

FIG. 2 illustrates a flow chart of a method for providing a customized plurality of lessons to a student user based on skills associated with the student user, according to some embodiments.

FIGS. 3, 4, 5, and 6 illustrate various screens of a graphical user interfaces for providing a customized plurality of lessons to a student user based on skills associated with the student user, according to some embodiments.

FIG. 7 illustrates a block diagram of a computer system, according to some embodiments.

The figures depict various embodiments of the present invention for purposes of illustration only, wherein the figures use like reference numerals to identify like elements. One skilled in the art will readily recognize from the following discussion that alternative embodiments of the structures and methods illustrated in the figures can be employed without departing from the principles of the invention described herein.

### DETAILED DESCRIPTION

Before the present invention is described in greater detail, it is to be understood that this invention is not limited to particular embodiments described, as such can, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges can independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

It is noted that, as used herein and in the appended claims, the singular forms “a”, “an”, and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements or use of a “negative” limitation.

As will be apparent to those of skill in the art upon reading this disclosure, each of the individual embodiments described and illustrated herein has discrete components and features which can be readily separated from or combined with the features of any of the other several embodiments without departing from the scope or spirit of the present invention. Any recited method can be carried out in the order of events recited or in any other order that is logically possible.

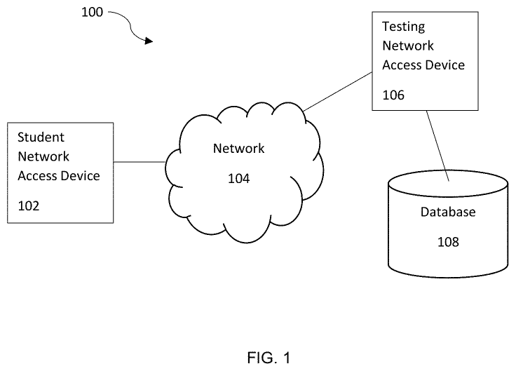

FIG. 1 illustrates system 100 for teaching skills. System 100 can include student network access device 102. In some embodiments, student network access device 102 is a computing device (e.g., tablet, smart phone, personal computer, special purpose computer) that a student has access to. In some embodiments, student network access device 102 includes access software (e.g., cloud application, mobile application) and a graphical user interface (GUI) that can be used to access a skill learning application.

In some embodiments, the access software is communicatively coupled to system 100 and for communication via network 104 (e.g., Internet, intranet, cellular) with testing network access device 106. In some embodiments, testing network access device 106 is a computing device (e.g., server, special purpose computer) that can be configured to configure and provide the skill learning application to student network access device 102. In some embodiments, the skill learning application can be an application that is accessed through a web browser of the student network access device 102 or via a unique graphical user interface installed on the student network access device 102. In some embodiments, testing network access device 106 is in communication with database 108, which can store, in memory, files related to student testing records and/or data for operating the skill learning application, such as tests, videos, and other testing and student information. The various files, records, student aptitude information, testing information and parameters, etc., that are discussed herein as being stored in the database 108 can also be stored within memory on the student network access device 102 and/or the testing network access device 106.

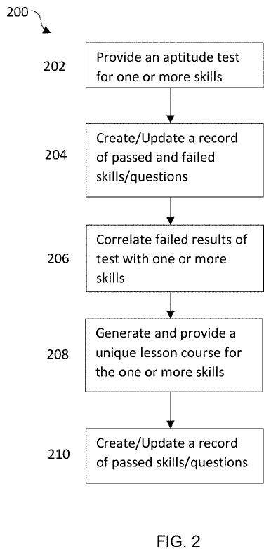

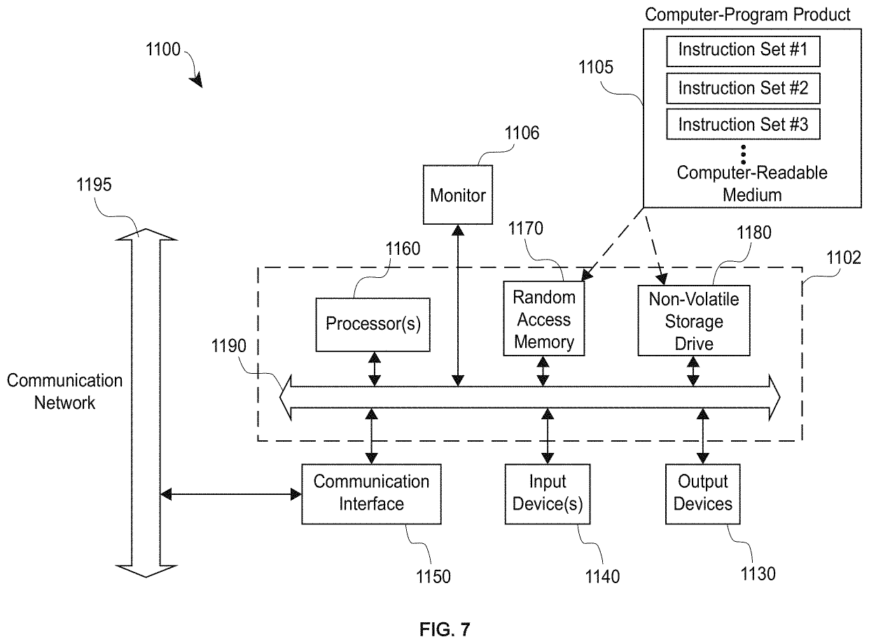

FIG. 2 illustrates method 200 that can be performed by one or more processors of a system, such as system 100 of FIG. 1 and/or system 1100 of FIG. 7. Accordingly, operation of method 200 can include some or all the aspects recited with respect to FIG. 1 and some not specifically recited. Method 200 can be stored as processor executable instructions on a non-transitory medium readable by the processor. The term “processor” is used broadly herein and may include one or more processing units or circuitry, such as one or more processors, microprocessors, hard and soft microprocessor cores, controllers, microcontrollers, etc., and can be embedded or non-embedded. The processor can be embedded or integrated, such as in an application-specific integrated circuit (ASIC) or field programmable gate array (FPGA), for example.

The processor can be configured to execute method 200. The order of execution of the operations of method 200 is exemplary, and in some embodiments, the order of execution can be switched. For example, in some embodiments, operation 206 can take place before operation 204. Further, in some embodiments, operations occur in parallel and/or some aspects of operations can be merged/subsumed into other operations.

At operation 202, an aptitude test can be provided to a student to test one or more skills. In some embodiments, the aptitude test can be provided to student network access device 102 by testing network access device 106 via network 104. In some embodiments, student network access device 102 can provide the aptitude test without interaction from testing network access device 106. In some embodiments, an aptitude test can include a plurality of multiple choice questions generated on a graphical user interface (GUI) of student network access device 102. In some embodiments, questions for an aptitude test can be selected based on testing network access device 106 accessing a student's past electronic record of testing to avoid repeat questions.

Aptitude tests are configured to test particular skills of a particular subject (e.g., mathematics, science, languages, programming). In some embodiments, the skills are the learned basis on how to solve a certain type of problem (i.e., problem solving skills). In some embodiments, an aptitude test can determine which, if any, subject areas a student requires skill improvement on. For example, in the context of math skills, an aptitude test can determine if a student requires skill improvement for one or more of addition, subtraction, multiplication, division, order of operations, averaging, graphing, matrices, and/or linear equations, etc. For example, in the context of language skills, an aptitude test can determine if a student requires skill improvement for one or more of spelling, listening, grammar, conjugation, and/or writing. For example, in the context of computer programming, an aptitude test can determine if a student requires skill improvement for one or more of variables, data structures, control structures, syntax, and/or tools. In some embodiments, an aptitude test can test include questions related to foundational problem solving skills required for competency of a problem solving skill at issue. For example, an aptitude test directed to non-linear equations can include questions related to linear equations. In this manner, lessons can be formulated to address the foundational failings of the student.

At operation 204, a student record or sub record (e.g., in the database 108) can be created or updated for recording test answers and operational data (e.g., any data outside of the test answers) associated with the aptitude test. At operation 206, the student has completed the test and the results can be analyzed by testing network access device 106 and/or student network access device 102. Any failed results of the aptitude test can be correlated to one or more particular skills that require improvement for the student to succeed in the tested subject matter. In some embodiments, failed questions are correlated by using a look-up table to directly correlate lessons with the one or more skills. In some embodiments, there are enough lesson variables (e.g., 500 problem questions) per skill and to make it impossible for a student to receive the same lesson question twice.

In some embodiments, machine learning (i.e., artificial intelligence) is employed to take into other factors in order to provide improved lessons for the student. In some embodiments, machine learning can be used to consider other factors outside of the answered questions to determine if lesson focus on particular skills is warranted, for example, if a student had past difficulty (e.g., a record of past failed questions in a particular skill or set of related skills) in learning a related skill, the amount of time taken to pass related skills that the student answered correctly for (e.g., if a student answered a question correctly, but took three times as long to answer the question, suggesting more lessons may be required, or if a student answered one or more questions particularly quickly in comparison to other students/past test records, suggesting the student should be placed ahead), the number of inputs/changes to a passed or failed questions (e.g., taking into consideration that a student initially entered the correct answer but ultimately changed the input into an incorrect answer, perhaps suggesting confidence and/or sloppiness issues), the time of day the student took the test, the last time the student took an aptitude test and/or completed lessons, whether other applications were being operated at the same time that can suggest dishonesty (e.g., calculator software, Internet access to teaching sites during the test) or attention issues (e.g., Internet access to social media sites), whether recorded facial reactions, hand movements, and/or eye movements (recorded by a camera of student network access device 102) of the student suggest a particular issue that is impairing the student (external distractions, sleep deprivation, learning disability, dishonesty, disinterest, stress, boredom). It is assumed that recording and considering more personal aspects of the student is done legally and with full permission/disclosure. The various information related to the student's performance, issues, past records or test taking parameters, etc., can be stored in the database 108, for instance, and later accessed as needed.

At operation 208, one or more lessons, and in some embodiments a plurality of lesson modules (i.e., a course) can be retrieved for each failed skill of the aptitude test. In some embodiments, the course can then be provided and generated for access to the student on the GUI. In some embodiments, generation of the course occurs in “real-time” from the perspective of the student, i.e., the course is generated in a few seconds/minutes of time and directly presented to the student after completion of the aptitude test. Accordingly, the student can begin the course while the confusion regarding the related one or more skills is fresh in their mind, which is particularly advantageous over a traditional classroom setting where tests are graded days after completion and directed lessons to the student may not occur at all. In some embodiments, a lesson module is designed to teach a portion of a greater skill and also designed so that following, related lessons modules for the same skill incrementally build on the foundation of the prior lesson module. In some embodiments, the connection between modules can be directly stated in the lesson modules by recapping what was previously taught and making a logical connection to what is currently being taught. In this manner, a student can logically connect a currently viewed lesson module to content of past lesson modules, which can foster learning the skill.

Lesson modules can be accessed by the student via the GUI. Each lesson module can include a user-selectable link/button for beginning/continuing the lesson, wherein in some embodiments a new window/GUI is opened. In some embodiments, the GUI for each lesson can include one or more reference sections, e.g., equations, definitions, a written lesson on how to learn a particular skill, that the student can refer to. In some embodiments, the course can be configured to track student time spent on the course. In some embodiments, the GUI for each lesson can include interactive elements such as buttons or other selectable elements to continue the lesson, e.g., in some embodiments there can be mandatory pauses within video lessons that require a student to confirm understanding of a particular lesson section before the lesson continues, and in some embodiments the particular lesson section can replay and/or be replaced with a lesson section that provides more information.

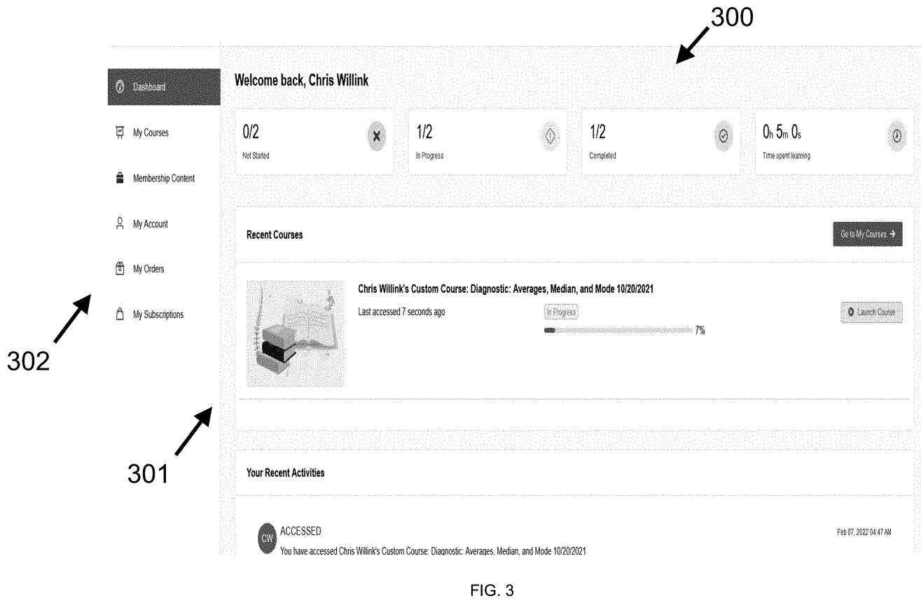

An example screen 300 of the GUI, according to an embodiment, is depicted at FIG. 3, which shows a launch area for the student to access a general information dashboard 301 (e.g., showing past courses/activities/completion rate), and clickable buttons 302 for accessing other aspects, such as a course of lessons, additional membership content, account information, orders/purchases, and subscriptions.

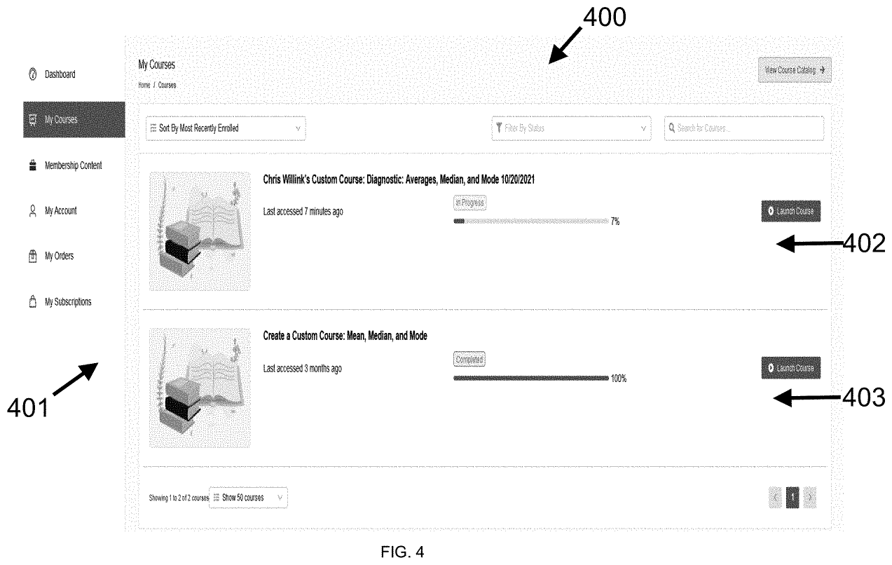

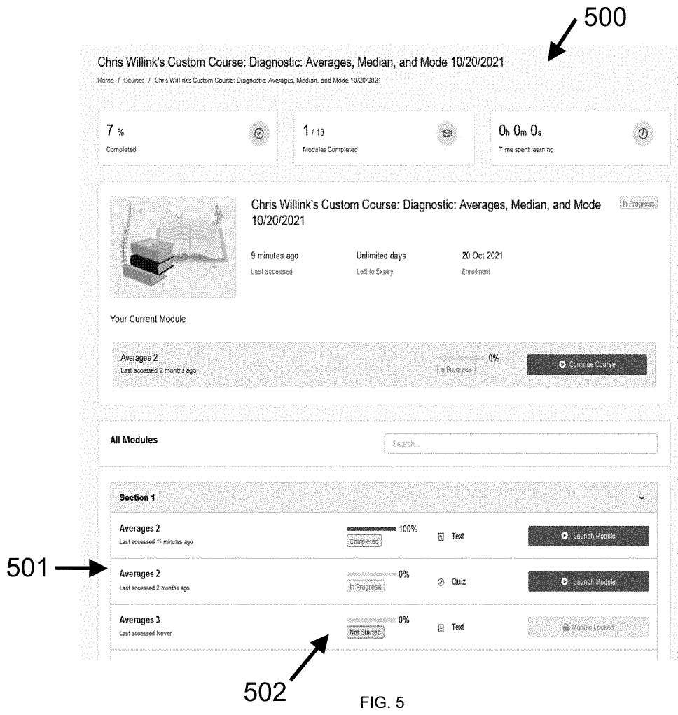

At FIG. 4, an example screen 400 of the GUI, according to an embodiment, includes the course section 401, which can include links to custom courses for the student. Progression on each lesson can be provided in the form of a sliding percentage bar (0-100%). Particular courses, such as the example courses 402, 403, can be assessed by clicking on them, which can change the GUI to the depiction shown at FIG. 5, which includes an example screen 500, according to an embodiment, that shows a plurality of accessible lesson modules 501, and information 502 regarding lesson module completion percentage and time spent on the course. A course can include severable lesson modules, which in some embodiments can only be iteratively accessed, i.e., a test or quiz must be passed before accessing a successive lesson module.

In some embodiments, each lesson module is an incremental facet of a greater subject, and in some embodiments adjacent lesson modules can overlap in content to maintain continuity between them. In some embodiments, lesson module tests (e.g., short format quizzes) are taken between each lesson module and must be passed in order to take the following lesson module. In some embodiments, initial tests for a skill are made purposely easy in order to help the student build confidence. In some embodiments, a student can be required by method 200 to retake a test because of failing, and in some embodiments, they can also be required to retake the associated lesson module, which can be reconfigured (e.g., made to focus on the failed test questions). In some embodiments, problems of the lesson module tests are selected from a database of possible questions and the database can be of a sufficient size (e.g., 100-500 questions) to ensure that by accessing the student's record, a student is never asked the same question for a particular skill or subskill.

In some embodiments, several lesson modules (e.g., 5-10 lesson modules per skill) can be provided on the GUI. Three lesson modules 501 are depicted, but several more that are not shown can be accessed by scrolling the screen down. Each lesson module can be launched by clicking an associated button.

In some embodiments, the GUI for each lesson module can include a playable media, such as a video format lesson. In some embodiments, the video format lesson can include separate sections, such as a question section that provides a problem. In some embodiments, the video format lesson includes a work area depiction that displays an animation for learning the skill (e.g., mimicking a white-board/chalk board execution to step-by-step solve an equation, pronounce a word, conjugate a verb). In some embodiments, the video format lesson includes animated close captioning and/or verbal playback of an explanation of the work area animation. In some embodiments, the video format lesson will be incremented into lesson sections where the video pauses between each section. In some embodiments, the video format lesson will intentionally/mandatorily pause and require the student to confirm understanding (e.g., by pressing a first button) before moving on to a next lesson section, and also replay the lesson section if the student indicates (e.g., by pressing a second button) they did not understand. In some embodiments, a video format lesson will be altered when a student indicates that they did not understand a particular lesson section, e.g., a first lesson section can be replaced by a second lesson section that provides more information than the first lesson section and/or provides information in a modified lesson format (e.g., more/less simplified, more/less in-depth, more/less animation, more/less text, more/less audio playback) than the first lesson section, and in some embodiments, a record associated with the student can be updated to record which lesson format the student learns best from (e.g., according to lesson section student inputs, testing results) and future lessons modules can be presented by accessing that record and creating a lesson module according to that student's preferences. The various records can be stored in the database 108 for instance.

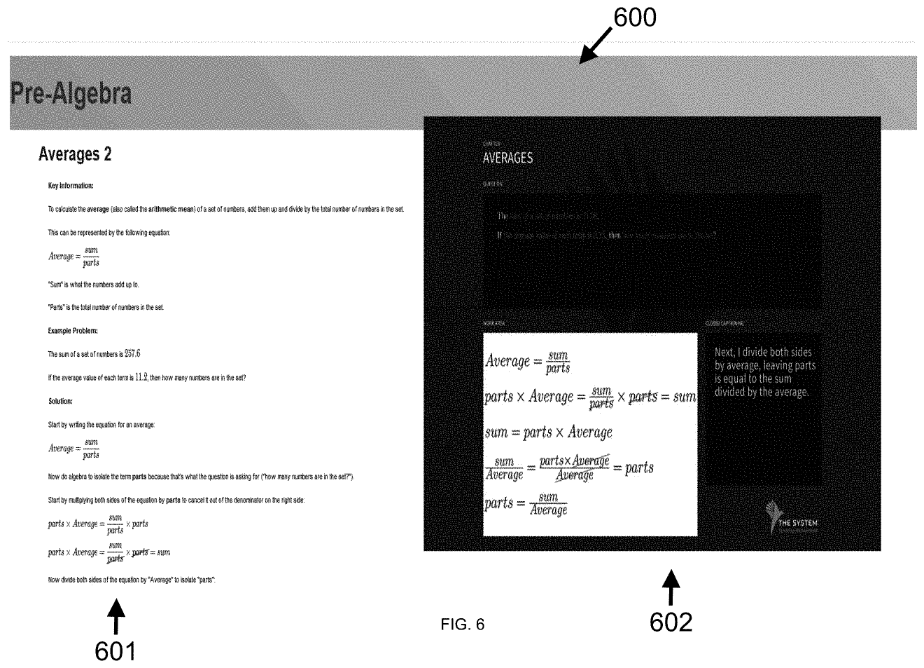

An example screen 600 of a GUI for a pre-algebra lesson module related to averaging, according to an embodiment, is shown at FIG. 6. Here, the GUI depicts a portion of reference section 601 (which can be scrolled downward farther), and a video window 602 on the right-side of the screen. In some embodiments, the video window includes a question section, which can be static, while a work area in white is animated, as well as an animated captioning section that describes what is occurring in the work area.

In some embodiments, after the lesson modules are completed, the student's record can be updated to record the completion. In some embodiments, the student can retake the same aptitude test or a different aptitude test in the same subject matter, to affirm the student's progress in learning the skill.

In some embodiments, the graphical user interface is provided by testing network access device 106 student network access device 102 in the manner commonly referred to as software as a service (SaaS), i.e., where processing method 200 is primarily or exclusively performed by testing network access device 106 based on inputs (e.g., log-ons, log-offs, entering test data) received from the graphical user interface of student network access device 102 and where student network access device 102 primarily or exclusively performs to generate the graphical user interface and send student inputs to testing network access device 106. In some embodiments, student network access device 102 cannot provide testing/lesson functions when not connected to network access device 106, i.e., method 200 can only be provided when student network access device 102 is “on-line” and logged in to testing network access device 106.

In some embodiments, student network access device 102 can be configured to primarily process method 200 for periods of time without interacting with testing network access device 106 except for periodic data management, for example to periodically update records and/or retrieve new lessons. Hence, allowing method 200 to operate “off-line” for periods of time. In some embodiments, student network access device 102 can be configured to exclusively process method 200 without interacting with testing network access device 106 after an initial download of executable code for method 200. Hence, allowing method 200 to operate “off-line” all of the time. In some embodiments, student network access device 102 can be configured to exclusively process method 200 without substantially interacting with testing network access device 106 after an initial download of executable code for method 200 from with testing network access device 106, for example, where the only interaction is to periodically update records and/or periodically verify licensing.

With reference to FIG. 7, an embodiment of a special-purpose computer system 1100 is shown, which can represent for example, student network access device 102 and/or testing network access device 102. For example, one or more intelligent components, processing system 110 and components thereof may be a special-purpose computer system 1100. Such a special-purpose computer system 1100 may be incorporated in part or whole as part of a saliva sampling device and/or any of the other computerized devices discussed herein, such as a remote server, mobile device, or network. The above methods may be implemented by computer-program products that direct a computer system to perform the actions of the above-described methods and components. Each such computer-program product may comprise sets of instructions (codes) embodied on a computer-readable medium that direct the processor of a computer system to perform corresponding actions. The instructions may be configured to run in sequential order, or in parallel (such as under different processing threads), or in a combination thereof. After loading the computer-program products on a general-purpose computer system 1126, it is transformed into the special-purpose computer system 1100.

Special-purpose computer system 1100 comprises a computer 1102, a monitor 1106 coupled to computer 1102, one or more additional user output devices 1130 (optional) coupled to computer 1102, one or more user input devices 1140 (e.g., keyboard, mouse, track ball, touch screen) coupled to computer 1102, an optional communications interface 1150 coupled to computer 1102, a computer-program product 1105 (e.g., method 200) stored in a tangible computer-readable memory in computer 1102. Computer-program product 1105 directs computer system 1100 to perform the above-described methods. Computer 1102 may include one or more processors 1160 that communicate with a number of peripheral devices via a bus subsystem 1190. These peripheral devices may include user output device(s) 1130, user input device(s) 1140, communications interface 1150, and a storage subsystem, such as random-access memory (RAM) 1170 and non-volatile storage drive 1180 (e.g., disk drive, optical drive, solid state drive), which are forms of tangible computer-readable memory.

Computer-program product 1105 may be stored in non-volatile storage drive 1180 or another computer-readable medium accessible to computer 1102 and loaded into random access memory (RAM) 1170. Each processor 1160 may comprise a microprocessor, such as a microprocessor from Intel® or Advanced Micro Devices, Inc.®, or the like. To support computer-program product 1105, the computer 1102 runs an operating system that handles the communications of computer-program product 1105 with the above-noted components, as well as the communications between the above-noted components in support of the computer-program product 1105. Exemplary operating systems include Windows® or the like from Microsoft Corporation, Solaris® from Sun Microsystems, LINUX, UNIX, and the like.

User input devices 1140 include all possible types of devices and mechanisms to input information to computer 1102. These may include a keyboard, a keypad, a mouse, a scanner, a digital drawing pad, a touch screen incorporated into the display, audio input devices such as voice recognition systems, microphones, and other types of input devices. In various embodiments, user input devices 1140 are typically embodied as a computer mouse, a touch screen, wireless remote, a drawing tablet, or a voice command system. User input devices 1140 typically allow a user to select objects, icons, text and the like that appear on the monitor 1106 via a command such as a click of a button or the like. User output devices 1130 include all possible types of devices and mechanisms to output information from computer 1102. These may include a display (e.g., monitor 1106), printers, non-visual displays such as audio output devices, etc.

Communications interface 1150 provides an interface to other communication networks, such as communication network 1195, and devices and may serve as an interface to receive data from and transmit data to other systems, WANs and/or the Internet. Embodiments of communications interface 1150 typically include an Ethernet card, a modem (telephone, satellite, cable, ISDN), a (asynchronous) digital subscriber line (DSL) unit, a FireWire® interface, a USBC® interface, a wireless network adapter, and the like. For example, communications interface 1150 may be coupled to a computer network, to a FireWire® bus, or the like. In other embodiments, communications interface 1150 may be physically integrated on the motherboard of computer 1102, and/or may be a software program, or the like.

RAM 1170 and non-volatile storage drive 1180 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1170 and non-volatile storage drive 1180 may be configured to store the basic programming and data constructs that provide the functionality of various embodiments of the present invention, as described above.

Software instruction sets that provide the functionality of the present invention may be stored in RAM 1170 and non-volatile storage drive 1180. These instruction sets or code may be executed by the processor(s) 1160. RAM 1170 and non-volatile storage drive 1180 may also provide a repository to store data and data structures used in accordance with the present invention. RAM 1170 and non-volatile storage drive 1180 may include a number of memories including a main random-access memory (RAM) to store instructions and data during program execution and a read-only memory (ROM) in which fixed instructions are stored. RAM 1170 and non-volatile storage drive 1180 may include a file storage subsystem providing persistent (non-volatile) storage of program and/or data files. RAM 1170 and non-volatile storage drive 1180 may also include removable storage systems, such as removable flash memory.

Bus subsystem 1190 provides a mechanism to allow the various components and subsystems of computer 1102 to communicate with each other as intended. Although bus subsystem 1190 is shown schematically as a single bus, alternative embodiments of the bus subsystem may utilize multiple busses or communication paths within the computer 1102.

Throughout the foregoing description, and for the purposes of explanation, numerous specific details are set forth in order to provide a thorough understanding of the described techniques. It will be apparent, however, to one skilled in the art that these techniques can be practiced without some of these specific details. Although various embodiments that incorporate these teachings have been shown and described in detail, those skilled in the art could readily devise many other varied embodiments or mechanisms to incorporate these techniques. Also, embodiments can include various operations as set forth above, fewer operations, or more operations; or operations in an order. Accordingly, the scope and spirit of the invention should be judged in terms of the claims, which follow as well as the legal equivalents thereof.

What is claimed is:

1. A computer-implemented method for providing a customized plurality of lessons to a student user based on skills of the student user, the computer-implemented method comprising:
generating and displaying, with one or more processors, an aptitude test on a graphical user interface, the aptitude test comprising a list of questions;
creating or updating, by the one or more processors, a record of the questions from the aptitude test, the record stored within memory;
correlating, by the one or more processors, failed results of the aptitude test with one or more skills;
generating, by the one or more processors, a plurality of lesson courses for the one or more skills; and
generating and displaying, by the one or more processors, the plurality of lesson courses on the graphical user interface.

2. The computer-implemented method of claim 1, wherein each lesson course of the plurality of lesson courses comprises a plurality of lesson modules.

3. The computer-implemented method of claim 2, wherein each lesson module comprises a video lesson and a static written lesson generated on the graphical user interface.

4. The computer-implemented method of claim 3, wherein the video lesson comprises a question portion regarding a problem, an animated portion illustrating a method of solving the problem, and a close captioned portion displaying animated text explanation of the animated portion.

5. The computer-implemented method of claim 3, wherein a first lesson module of the plurality of lesson modules comprises a first video lesson and a first quiz.

6. The computer-implemented method of claim 5, wherein a second lesson module of the plurality of lesson modules is not accessible on the graphical user interface until the first quiz is passed.

7. The computer-implemented method of claim 3, wherein the plurality of lesson courses comprises a plurality of quiz questions, and wherein the plurality of quiz questions is selected to not repeat questions from the record.

8. The computer-implemented method of claim 7, wherein the plurality of quiz questions is selected from a database comprising more than 100 questions.

9. The computer-implemented method of claim 1, wherein the plurality of lesson courses are generated only for the one or more skills and not for skills passed in the aptitude test.

10. A computer system comprising a display, at least one processor, and memory comprising instructions, which when executed by the at least one processors, cause the at least one processor to perform a method for providing a customized plurality of lessons to a student user based on skills associated with the student user, the method comprising:
generating and displaying an aptitude test on a graphical user interface on the display, the aptitude test comprising a list of questions;
creating or updating a record of the questions from the aptitude test, the record stored within the memory;
correlating failed results of the aptitude test with one or more skills;
generating a plurality of lesson courses for the one or more skills; and
generating and displaying the plurality of lesson courses on the graphical user interface on the display.

11. The computer system of claim 10, wherein each lesson course of the plurality of lesson courses comprises a plurality of lesson modules.

12. The computer system of claim 11, wherein each lesson module comprises a video lesson and a static written lesson generated on the graphical user interface.

13. The computer system of claim 12, wherein the video lesson comprises a question portion regarding a problem, an animated portion illustrating a method of solving the problem, and a close captioned portion displaying animated text explanation of the animated portion.

14. The computer system of claim 12, wherein a first lesson module of the plurality of lesson modules comprises a first video lesson and a first quiz.

15. The computer system of claim 14, wherein a second lesson module of the plurality of lesson modules is not accessible on the graphical user interface until the first quiz is passed.

16. The computer system of claim 12, wherein the plurality of lesson courses comprises a plurality of quiz questions, and wherein the plurality of quiz questions is selected to not repeat questions from the record.

17. The computer system of claim 16, wherein the plurality of quiz questions is selected from a database comprising more than 100 questions.

18. The computer system of claim 10, wherein the plurality of lesson courses are generated only for the one or more skills and not for skills passed in the aptitude test.

19. A computer-program product comprising a sets of instructions embodied on a non-transitory computer-readable medium that direct one or more processors of a computer system to perform a method for providing a customized plurality of lessons to a student user based on skills associated with the student user, the method comprising:
generating and displaying an aptitude test on a graphical user interface on a display of the computer system, the aptitude test comprising a list of questions;
creating or updating a record of the questions from the aptitude test, the record stored within memory of the computer system;
correlating failed results of the aptitude test with one or more skills;
generating a plurality of lesson courses for the one or more skills; and
generating and displaying the plurality of lesson courses on the graphical user interface on the display.

20. The computer-program product of claim 19, wherein each lesson course of the plurality of lesson courses comprises a plurality of lesson modules;
wherein the plurality of lesson courses comprises a plurality of quiz questions, and wherein the plurality of quiz questions is selected to not repeat questions from the record;
wherein the plurality of quiz questions is selected from a database comprising more than 100 questions; and
wherein the plurality of lesson courses are generated only for the one or more skills and not for skills passed in the aptitude test.
